(19) United States
(12) Patent Application Publication
(10) Pub. No.: US 2011/0301058 A1
(43) Pub. Date: Dec. 8, 2011

(54) MICROFLUIDIC DEVICE

(75) Inventors: Ji-Yen Cheng, Taoyuan County (TW); Joel Chia-Yeh Chang, Taipei City (TW); Ching-Wen Yang, New Taipei City (TW)

(73) Assignee: ACADEMIA SINICA, Taipei (TW)

(21) Appl. No.: 13/156,250

(22) Filed: Jun. 8, 2011

Related U.S. Application Data
(60) Provisional application No. 61/352,431, filed on Jun. 8, 2010.

(51) Int. Cl. C40B 30/04; C40B 99/00; C40B 60/12

(52) U.S. Cl. 506/9; 506/39; 506/43

(57) ABSTRACT

A novel approach for fabricating Monolithic Internal micro Pillars (MIPi) made of SU-8 photoresist is described. A microfluidic chip with the internal pillars (a MIPi chip) was used for cell capturing study. The surface of MIPi was coated with specific antibody and then used for capturing cells by affinity binding. An antibody, anti-EGFR, which has high affinity to lung cancer cells, CL1-5, was coated on the micro pillars. The coated MIPi chip specifically captured the cancer cells that were pumped through the MIPi chip. Simulation and experiment was carried out to compare the effect of different geometry of the micro pillars on the cell capturing rate.

### CROSS REFERENCE TO RELATED APPLICATIONS

This application claims the benefit of U.S. Provisional Application No. 61/352,431, filed Jun. 8, 2010.

### BACKGROUND OF THE INVENTION

A microfluidic device often includes microstructures inside a microchamber. The microstructure can be of diverse function such as mixing, cell capturing, optical wave guiding, etc. Traditionally, structures inside a microchamber are fabricated by bonding multiple layers together. For example, a sandwiched structure has three layers, the bottom layer, the internal structure layer, and the cover layer. These three layers need to be bonded together so that the sandwiched structure can be fabricated. If one of the three layers is not smooth, the bonding fails and leakage occurs. For the conventional three-layered microfluidic device, alignment is often needed when bonding multiple layers that have patterns.

Cell capturing plays an important role in medical analyses and has been receiving intensive attention in recent years. For example, the presence of circulating tumor cells (CTCs) has been associated with poor prognosis in patients with metastatic breast cancer (Cristofanilli, M., Budd, G. T., Ellis, M. J., Stopeck, A., Matera, J., Miller, M. C., Reuben, J. M., Doyle, G. V., Allard, W. J., Terstappen, L. W. and Hayes, D. F. (2004) Circulating tumor cells, disease progression, and survival in metastatic breast cancer. N Engl J Med. 351, 781-791). Capturing CTCs in biological samples of metastatic cancer patients allows better characterization of CTCs, which could provide additional information to augment management of the disease (Smirnov, D. A., Zweitzig, D. R., Foulk, B. W., Miller, M. C., Doyle, G. V., Pienta, K. J., Meropol, N. J., Weiner, L. M., Cohen, S. J., Moreno, J. G., Connelly, M. C., Terstappen, L. W. and O'Hara, S. M. (2005) Global gene expression profiling of circulating tumor cells. Cancer Res. 65, 4993-4997).

Immunomagnetic beads has been the leading technology in clinical detection of CTC from peripheral blood samples (Smirnov, D. A., Zweitzig, D. R., Foulk, B. W., Miller, M. C., Doyle, G. V., Pienta, K. J., Meropol, N. J., Weiner, L. M., Cohen, S. J., Moreno, J. G., Connelly, M. C., Terstappen, L. W. and O'Hara, S. M. (2005) Global gene expression profiling of circulating tumor cells. Cancer Res. 65, 4993-4997). Recently, microfluidic devices have been successfully used for rapid CTC detection (Nagrath, S., Sequist, L. V., Maheswaran, S., Bell, D. W., Irimia, D., Ulkus, L., Smith, M. R., 30 Kwak, E. L., Digumarthy, S., Muzikansky, A., Ryan, P., Balis, U. J., Tompkins, R. G., Haber, D. A. and Toner, M. (2007) Isolation of rare circulating tumour cells in cancer patients by microchip technology. Nature. 450, 1235-U1210; Xu, Y., Phillips, J. A., Yan, J. L., Li, Q. G., Fan, Z. H. and Tan, W. H. (2009) Aptamer-Based Microfluidic Device for Enrichment, Sorting, and Detection of Multiple Cancer Cells. Analytical Chemistry. 81, 7436-7442; Gleghorn, J. P., Pratt, E. D., Denning, D., Liu, H., Bander, N. H., Tagawa, S. T., Nanus, D. M., Giannakakou, P. A. and Kirby, B. J. (2009) Capture of circulating tumor cells 5 from whole blood of prostate cancer patients using geometrically enhanced differential immunocapture (GEDI) and a prostate-specific antibody. Lab Chip. 10, 27-29). In a previous study, anti-epithelial-cell-adhesion-molecule (anti-EpCAM) antibody is functionalized on the silicon (Si) microposts for specific binding between the cancer cells and the microposts (Nagrath, S., Sequist, L. V., Maheswaran, S., Bell, D. W., Irimia, D., Ulkus, L., Smith, M. R., 30 Kwak, E. L., Digumarthy, S., Muzikansky, A., Ryan, P., Balis, U. J., Tompkins, R. G., Haber, D. A. and Toner, M. (2007) Isolation of rare circulating tumour cells in cancer patients by microchip technology. Nature. 450, 1235-U1210). The Si micropost array is fabricated using surface micromachining such as deep reactive ion etching (DRIE) (Nagrath, S., Sequist, L. V., Maheswaran, S., Bell, D. W., Irimia, D., Ulkus, L., Smith, M. R., 30 Kwak, E. L., Digumarthy, S., Muzikansky, A., Ryan, P., Balis, U. J., Tompkins, R. G., Haber, D. A. and Toner, M. (2007) Isolation of rare circulating tumour cells in cancer patients by microchip technology. Nature. 450, 1235-U1210; Gleghorn, J. P., Pratt, E. D., Denning, D., Liu, H., Bander, N. H., Tagawa, S. T., Nanus, D. M., Giannakakou, P. A. and Kirby, B. J. (2009) Capture of circulating tumor cells 5 from whole blood of prostate cancer patients using geometrically enhanced differential immunocapture (GEDI) and a prostate-specific antibody. Lab Chip. 10, 27-29), which is a relatively expensive process. The microposts array is then clamped between a bottom cover and a top cover so that a sealed chamber can be formed as is done for most conventional microfluidic devices (Nagrath, S., Sequist, L. V., Maheswaran, S., Bell, D. W., Irimia, D., Ulkus, L., Smith, M. R., 30 Kwak, E. L., Digumarthy, S., Muzikansky, A., Ryan, P., Balis, U. J., Tompkins, R. G., Haber, D. A. and Toner, M. (2007) Isolation of rare circulating tumour cells in cancer patients by microchip technology. Nature. 450, 1235-U1210; Huang, C. W., Cheng, J. Y., Yen, M. H. and Young, T. H. (2009) Electrotaxis of lung cancer cells in a multiple-electric-field chip. Biosens Bioelectron. 24, 3510-3516 10; Hsu, T. H., Yen, M. H., Liao, W. Y., Cheng, J. Y. and Lee, C. H. (2009) Label-free quantification of asymmetric cancer-cell filopodium activities in a multi-gradient chip. Lab Chip. 9, 884-890). Sample is then pumped through the sealed chamber that holds the Si microposts for cancer cell capturing. In such fabrication approach, successful bonding is essential for sealing.

SU-8 2015 is a polymeric photoresist that has been used as a bonding layer to bond Si and glass in microfluidic devices (Jackman, R. J., Floyd, T. M., Ghodssi, R., Schmidt, M. A. and Jensen, K. F. (2001) Microfluidic systems with on-line UV detection fabricated in photodefinable epoxy. Journal of 15 Micromechanics and Microengineering. 11, 263-269; Chen, Y. T. and Lee, D. (2007) A bonding technique using hydrophilic SU-8. Journal of Micromechanics and Microengineering. 17, 1978-1984). SU-8 has also been utilized for constructing microchannel and boding between glass and glass, glass and PDMS, or Si and PDMS (Chen, Y. T. and Lee, D. (2007) A bonding technique using hydrophilic SU-8. Journal of Micromechanics and Microengineering. 17, 1978-1984).

There remains a need of a microfluidic device for rapid cell capturing that is easy to fabricate. Such microfluidic device is fabricated and used in the present invention.

### BRIEF SUMMARY OF THE INVENTION

It is now discovered that a monolithic sandwiched micropost array can be fabricated without using a bonding step. The obtained sandwiched micropost array (SMA) chip has internal channel that allows fluid to flow through as well as good sealing between the internal structure and the bottom/cover layers. The fabrication procedure greatly increases the successful rate in fabricating a sandwiched microfluidic device by omitting the bonding process.

In one general aspect, the present invention relates to a microfluidic device comprising a monolithic internal micro pillar (MIPi) array fabricated from SU-8 photoresist.

According to an embodiment of the present invention, the MIPi is coated with antibodies, such as anti-epidermal growth factor receptor (anti-EGFR) or Cy-5-anti mouse IgG (anti-mouse IgG).

In another general aspect, the present invention relates to a method of fabricating a microfluidic device. The method comprises fabricating a monolithic internal micro pillar array from SU-8 photoresist without using a bonding step.

Another general aspect of the invention relates to a method of capturing a cell in a sample. The method comprises applying the sample to a microfluidic device, wherein the microfluidic device comprises a monolithic internal micro pillar array fabricated from SU-8 photoresist.

According to an embodiment of the present invention, the surface of the monolithic internal micro pillar array is coated with an antibody specific to a surface protein of a cell, such as a cancer cell. The cell is captured via antibody-antigen interaction when a sample comprising the cell is applied to the microfluidic device.

According to another embodiment of the present invention, the sample is a biological sample from a patient, and the microfluidic device is used for cancer diagnosis or prognosis.

Other aspects, features and advantages of the invention will be apparent from the following disclosure, including the detailed description of the invention and its preferred embodiments and the appended claims.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIGS. 1A˜1D illustrate a fabrication procedure of a MIPi chip according to an embodiment of the present invention;

FIG. 1E shows the cross section of a MIPi chip according to an embodiment of the present invention;

FIG. 1F shows the top view of a MIPi chip according to an embodiment of the present invention;

FIG. 1G is the top view of a MIPi array arrangement according to an embodiment of the present invention and the illustration of the contact point according to an embodiment of the present invention: the vertical spacing (Y) is fixed at 80±5 μm and the pillar length (X) changes from 130 to 350±5 μm; open ratio (OR) is defined as Y/(X+Y); the horizontal pitch (P) and the pillar width (t) are 130 and 50±5 μm, respectively; the length of the entire MIPi array (L) for cell capturing is 16 to 48 columns of pillars, which correspond to about 2 to 6 mm; the liquid flow is from left to right; T and N denote the tangential line and the normal line, respectively, at a cell contact point;

FIG. 2A is the flow field in a MIPi array having a first open ratio (OR): the pillars for shear stress analysis are marked with a cross;

FIG. 2B is the flow field in a MIPi array having a second OR: the pillars for shear stress analysis are marked with a cross;

FIG. 2C is the flow field in a MIPi array having a third OR: the pillars for shear stress analysis are marked with a cross;

FIG. 2D illustrates the shear stress of the three configurations in FIGS. 2A˜2C when incoming flow speed was set as Vᵢₙ=0.8 mm/sec;

FIG. 3A is a bright-field image of a MIPi array according to an embodiment of the present invention with captured cancer cells, wherein the insert shows a magnified view of a captured cell;

FIG. 3B are confocal microscopic images of the internal pillars of the MIPi array in FIG. 3A, which show the images of the glass layers (top), the internal SU-8 micro pillars (middle) and the integrated view (bottom), in which the height of the pillar is 140 μm; the measured length and width of the pillar are 150 and 80 μm, respectively; an antibody, Cy-5-conjugated anti-mouse IgG, is used for SU-8 surface coating; the scale bar is 200 μm;

FIG. 4A shows the CL1-5 cell capturing rate of bare-MIPi chip, anti-mouse IgG coated-MIPi chip, and anti-EGFR-coated MIPi chip: the concentration of the antibodies was 20 μg/ml; OR40 was used;

FIG. 4B shows the CL1-5 cell capturing rate by MIPi chips with different open ratios (ORs);

FIG. 5 shows the effect of the antibody concentrations on the cell capturing rate (CR), wherein, at the lower concentration range, the capturing rate decreases with increasing anti-mouse IgG concentration, indicating the ability of the antibody to prevent non-specific binding; the CR reaches minimum at about 20 μm/mL, at the same concentration of anti-EGFR, the capturing rate reaches maximum; the cell velocity was 0.8 mm/sec; the MIPi chip has 16 columns of pillar; OR40 was used; and

FIG. 6 shows the number of cells captured by each column of pillars in the MIPi chip (open square) and the relative capture rate (filled circle): the column number is from the upstream to the downstream and the relative capture rate is calculated by dividing the accumulated number of captured cells by the total number of captured cells.

### DETAILED DESCRIPTION OF THE INVENTION

Unless defined otherwise, all technical and scientific terms used herein have the same meaning as commonly understood to one of ordinary skill in the art to which this invention pertains. In this application, certain terms are used, which shall have the meanings as set in the specification. It must be noted that as used herein and in the appended claims, the singular forms “a,” “an,” and “the” include plural reference unless the context clearly dictates otherwise.

Microfluidic devices according to embodiments of the present invention utilize SU-8 photoresist for the fabrication of monolithic internal micro pillars (abbreviated as MIPi). In such an approach, internal micro pillars are cured inside a micro chamber, therefore omitting the bonding step during the fabrication. This approach greatly reduced the fabrication time and the leakage caused by the poor bonding. In addition, complicated structures for mixing or wave-guiding can also be fabricated using the procedure of this invention.

In addition, using SU-8 as the micro pillars makes it easy for antibody coating. Although conventionally conceived as a stable polymer, antibody coating on SU-8 has been reported recently (Blagoi, G., Keller, S., Johansson, A., Boisen, A. and Dufva, M. (2008) Functionalization of SU-8 photoresist surfaces with IgG proteins. Applied Surface Science. 255, 2896-2902). The residual epoxy group on SU-8 surface reacts effectively with both amino and cysteine residues on proteins (Blagoi, G., Keller, S., Johansson, A., Boisen, A. and Dufva, M. (2008) Functionalization of SU-8 photoresist surfaces with IgG proteins. Applied Surface Science. 255, 2896-2902), e.g. antibodies, so that protein molecules are covalently linked to the SU-8 surface. This property of SU-8 greatly simplifies the antibody coating on the micro pillars. Passivation coating of the SU-8 surface with a protein that does not specifically bind to a cell eliminates non-specific capturing of the cell by the bare surface. For example, coating the SU-8 surface with anti-mouse IgG eliminates non-specific capturing of cancer cells, CL1-5. Active coating of the SU-8 surface with a protein that specifically binds to a cell results in specific capturing of the cell. For example, the MIPi coated with anti-EGFR resulted in the capture of cancer cells having EGFR. An exponential function was used to fit the cell capturing data and was used as a guideline for efficient design of optimal number of micro pillars. It is estimated that the overall capturing rate could reach 84% when 45 columns of pillars are used. Further increasing the array length may not further increase the overall capturing rate. Coating the SU-8 surface with multiple antibodies is expected to increase overall capturing rate.

Microfluidic devices according to embodiments of the present invention can be used in diagnosis and prognosis of a disease or condition in a subject, e.g., by capturing or detecting the presence of a cell specifically correlated with the disease or condition in a biological sample of the patient.

This invention will be better understood by reference to the non-limiting examples that follow, but those skilled in the art will readily appreciate that the examples are only illustrative of the invention as described more fully in the claims which follow thereafter.

### EXAMPLE

### Materials and Methods

Monolithic Internal Micro Pillar (MIPi) Chip

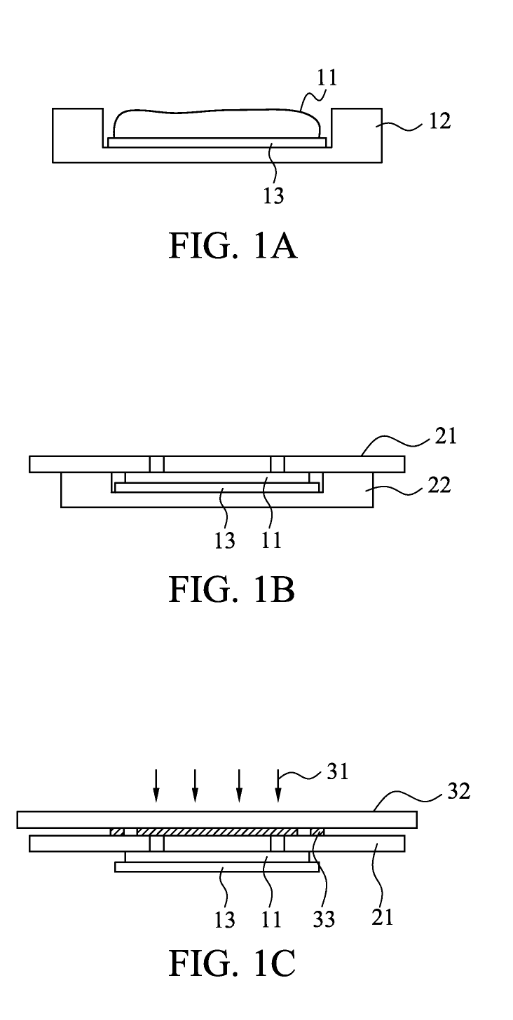

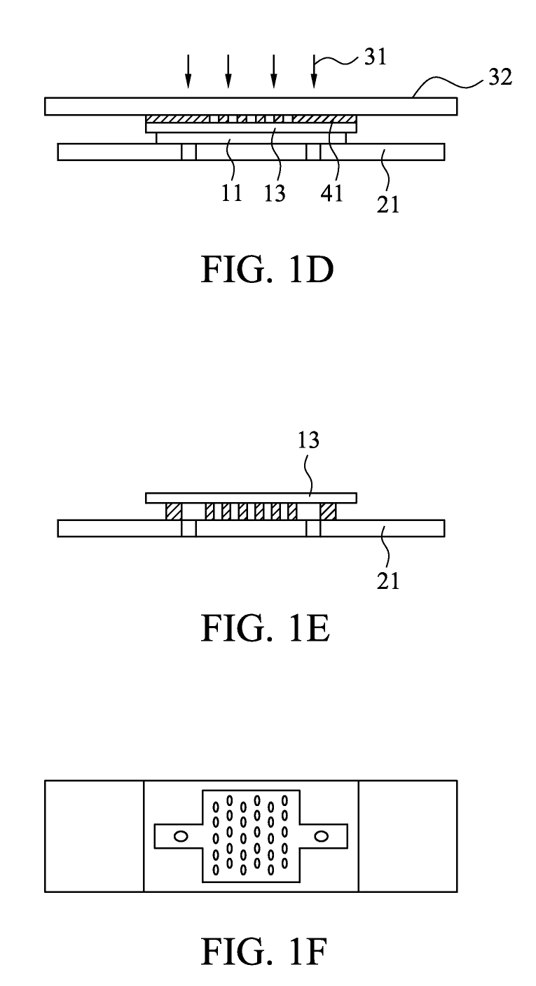

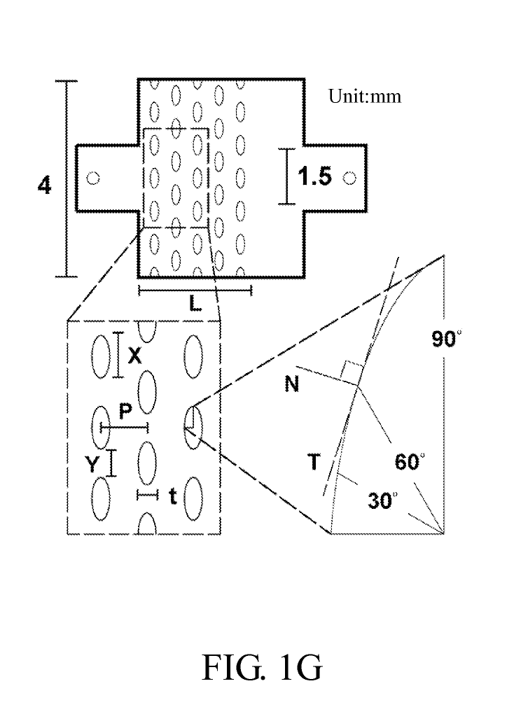

A MIPi chip was fabricated using a procedure as follows. One piece of cover glass and one piece of glass slide were first cleaned by isopropanol (IPA) and then immersed in 2N sulfuric acid (H₂SO₄) for 10 seconds. The substrates were then rinsed by de-ionized water and dried by nitrogen gas. The SU-8 photoresist (11) (MicroChem, 2015) was then dispensed on the cover glass (13) by a pipette (FIG. 1A). The cover glass (13) was put on a fixture (12) which has a groove of predetermined depth (FIG. 1A). A scraper was used to remove excess SU-8 so that an SU-8 layer with thickness of 210 μm was obtained. The depth of the groove can be adjusted to control the SU-8 thickness. Comparing to spin coating, this scrape coating method consumes less photoresist. The cover glass was then put on a hot plate for soft baking at 65° C. for six minutes. The resist-coated cover glass (13) was then put on a second fixture (22) (FIG. 1B). The glass slide (21) was then stacked on the SU-8 layer (11) and the second fixture (22) to form a monolithic chip. The glass slide (21) had two holes for effusion of un-cured SU-8 (11) resist during development. The two holes were also used for cell flow in the cell capturing experiment.

The internal microstructures, a peripheral frame and the micro pillars, were cured in two stages. The first stage cured the peripheral frame which was for liquid confinement. The second stage cured the internal micro pillars which were used for antibody immobilization. Plastic films were used as the photomasks. An expanded laser beam (355 nm, EKSPLA NL201/TH) or a UV lamp (Hamamatsu L8333-02) was used as the curing light source (31). Similar curing effects were obtained using the two light sources. For exposure of the frame structure, the photomask (33) was put in contact with the glass slide (21) (FIG. 1C). The exposure condition was 35 mW/cm² for 15 seconds. For the micro pillars, the photomask (41) was put in contact with the cover glass (13) (FIG. 1D). The condition was 1.2 mW/cm² for 110 seconds. A piece of quartz glass (32) was stacked on the photomask (33, 41) to ensure close contact (FIGS. 1C˜1D). After exposure, the monolithic chip was then put on a hot plate and baked at 65° C. for 5 minute to complete the SU-8 curing process. For developing the pattern, the monolithic chip was immersed in 4-hydroxy-4-methyl-2-pentanone (Sigma cat. No. HG41544-4L) and sonicated for 90 minutes. The holes on the glass slide allow the escape of uncured photoresist. After development, a MIPi chip was obtained (FIGS. 1E˜1F). It can be used directly without packaging or bonding. The MIPi was then rinsed with isopropanol and dried with nitrogen gas.

MIPi Array Arrangement and Flow Simulation

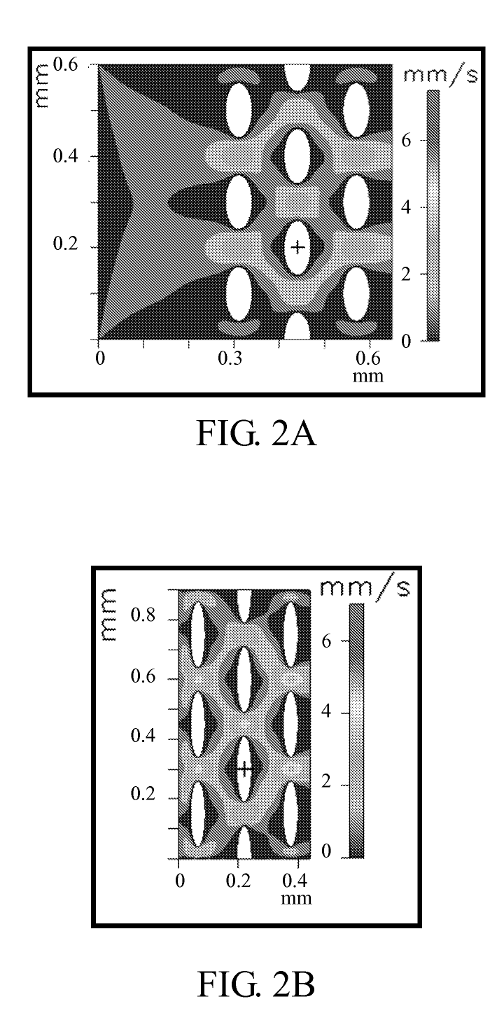

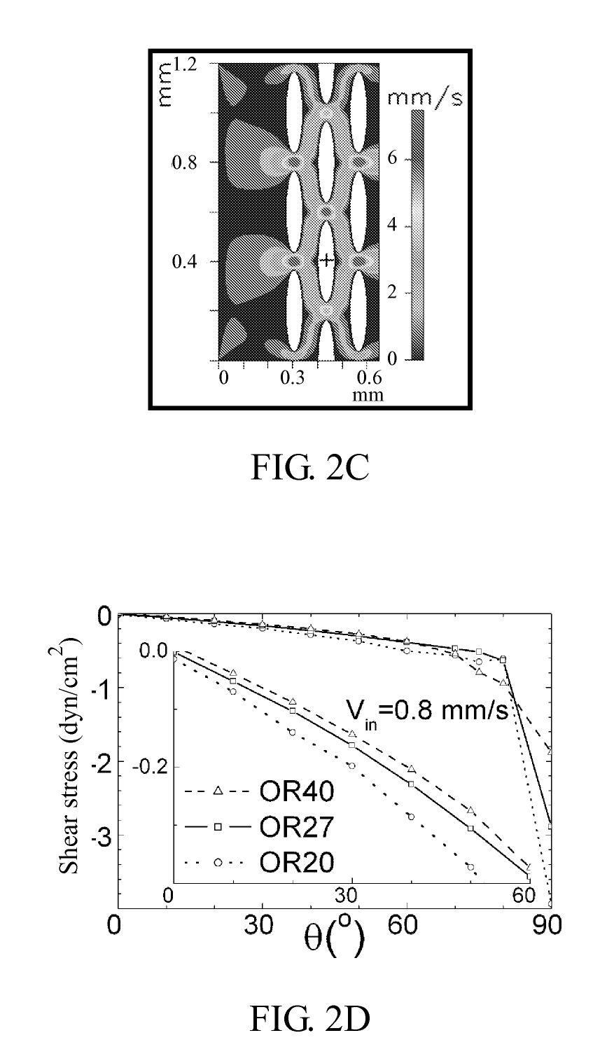

In this Example, oval cylinder micro pillars were used in attempt to increase the contact probability between flowing cells and the SU-8 pillars. Other shapes of pillars can also be used. It is conjectured that longer oval could result in higher contact probability. In addition, adjacent columns of the pillars can be shifted vertically in position, as shown in FIG. 1G and FIGS. 2A˜2C. Similar enhanced geometry was described very recently (Gleghorn, J. P., Pratt, E. D., Denning, D., Liu, H., Bander, N. H., Tagawa, S. T., Nanus, D. M., Giannakakou, P. A. and Kirby, B. J. (2009) Capture of circulating tumor cells 5 from whole blood of prostate cancer patients using geometrically enhanced differential immunocapture (GEDI) and a prostate-specific antibody. Lab Chip. 10, 27-29). In such an arrangement, every pillar is located at the center of the opening of the two upstream pillars to thus obtain cell contact probability larger than that in the arrangement where some pillars are in line with the upstream pillars (Nagrath, S., Sequist, L. V., Maheswaran, S., Bell, D. W., Irimia, D., Ulkus, L., Smith, M. R., 30 Kwak, E. L., Digumarthy, S., Muzikansky, A., Ryan, P., Balis, U. J., Tompkins, R. G., Haber, D. A. and Toner, M. (2007) Isolation of rare circulating tumour cells in cancer patients by microchip technology. Nature. 450, 1235-U1210).

An alternative approach for enhancing the pillar-cell contact is to increase the length (X in FIG. 1G) of the micro pillars. Oval-shaped pillar with three open ratios, defined as OR=Y/(X+Y), where Y is the vertical spacing, were designed. The X, Y of the miro pillar and the array length (L) were determined by the plastic photomask used in the photomask design. Photomasks for nominal OR values, OR20, OR27 and OR40, were used for the fabrication. Flow simulations for different ORs were conducted. The results were used to explain the experimental cell capturing rate. For comparing the shear stress on pillars of different OR, the contacting position was defined, as shown in FIG. 1G. The horizontal pitch (P) and the pillar width (t) were kept unchanged at 130 μm and 50±5 μm, respectively. The length of the entire MIPi array (L) for cell capturing was 16 to 48 columns of pillars, which corresponds to about 2 to 6 mm.

Flow field and shear stress were calculated using a fluidic dynamic simulation software CFD−ACE+ (ESI Group). To simplify the simulation, the smallest unit cell consisting of eight complete pillars and two half pillars (FIGS. 2A, 2B and 2C) was modeled and used for calculation. The flow velocity flowing into the MIPi array was set to be 0.8 mm/sec. Zero-back pressure was set at the fluidic outlet. Non-slip boundary condition was set at the channel wall and the pillar surface. The fluidic density and viscosity were set as 1000 kg/m³ and 0.000855 kg-s/m, respectively. For shear stress calculation, the flow velocities tangential to the pillar at 5 μm away from the surface were used.

Antibody Coating and Cell Affinity Capturing

The inlet and the outlet on the MIPi chip were connected with two adaptors. The upstream adaptor was connected with a 1 ml pipette tip (Axygen). The downstream adaptor was connected to a syringe pump (New Era Pump Systems, Inc. NE-1000). The tip was used as a reagent reservoir. The syringe pump was used to draw the reagents and the sample at controlled flow rate. For antibody coating, the chip was first rinsed with 1 ml ethanol and then 10 ml phosphate buffered saline (PBS) by manual pumping. Care was taken to avoid bubble formation inside the chip. 300 μl antibody (purified mouse anti-human EGF receptor (anti-EGFR, from Millipore cat. No. AP1245); or Cy-5-conjugated-goat anti-mouse IgG (anti-mouse IgG, from BD Pharmingen cat. No. 55596) with concentration 20 ug/ml in PBS buffer was then introduced into the chip and incubated at room temperature for 30 minutes. 1 ml PBS was then pumped through the MIPi chip at 0.5 ml/min to wash away unbound antibody.

For cell affinity capturing experiment, 1 ml of suspended CL1-5 cells in PBS at a concentration of 2000 cells/ml was pipetted into the tip. Flow rate was 400 to 600 μL/hr. Actual flow speed inside the MIPi chip was confirmed by flowing through micro beads (Bangs Laboratories) with diameter of 5.9 μm. The cell velocity flowing into the MIPi chip was 0.8 mm/sec, controlled by the drawing rate (˜500 μL/hr) of the syringe pump. In order to maintain the cells in suspension during the experiment, an additional syringe pump was used to pump air bubbles into the reagent reservoir, creating gentle turbulent mixing. The second syringe pump is essential for preventing clogging when high cell density was used. The air flow rate was 20 ml/hr. The MIPi chip was secured on an X-Y motorized stage mounted on a microscope (Olympus CKX41). Images of the pillars and cells were taken by a CCD camera (Thorlab DCU224M). Detail on the imaging system is described in the previous publication (Huang, C. W., Cheng, J. Y., Yen, M. H. and Young, T. H. (2009) Electrotaxis of lung cancer cells in a multiple-electric-field chip. Biosens Bioelectron. 24, 3510-3516; Cheng, J. Y., Yen, M. H., Kuo, C. T. and Young, T. H. (2008) A transparent cell-culture microchamber with a variably controlled concentration gradient generator and flow field rectifier. Biomicrofluidics. 2, 24105). The contents of which are incorporated here by reference.

Determination of Cell Capturing Rate

Video was taken when CL1-5 cells were pumped through the MIPi chip. The number of cells flowing into the chip and that attached on the internal pillars were monitored and counted. The cell capturing rate was determined by dividing the number of captured cells by the number of cells flushed into the MIPi chip. For observing the entire array so that all incoming, captured, and outgoing cells could be counted, 16 columns of micro pillars were used in the experiments unless stated otherwise.

MIPi Structure Observation by Confocal Microscopy

The internal SU-8 micro pillars were examined by a confocal microscope. The pillars were coated with the anti-mouse IgG and then observed by a confocal microscope (Leica, TCS SP5). The excitation wavelengths were set as 405 nm and 633 nm for the glass layers and the SU-8 layer, respectively. The corresponding emission filters were set at 385-425 nm and 665-685 nm, respectively

### Result and Discussion

Simulated Flow Field and Shear Stress

FIGS. 2A˜2D shows the simulated flow field and shear stress in the MIPi arrays with different OR. In FIGS. 2A, 2B and 2C, the incoming velocity was set at 0.8 mm/sec. The well-developed flow field started at the region between the left and the middle column. Since the pillars were arranged at the openings of the upstream columns, no stagnant region was observed. For comparison, prominent stagnant regions exist in the arrangement in which pillars are in-line with upstream ones (Nagrath, S., Sequist, L. V., Maheswaran, S., Bell, D. W., Irimia, D., Ulkus, L., Smith, M. R., 30 Kwak, E. L., Digumarthy, S., Muzikansky, A., Ryan, P., Balis, U. J., Tompkins, R. G., Haber, D. A. and Toner, M. (2007) Isolation of rare circulating tumour cells in cancer patients by microchip technology. Nature. 450, 1235-U1210). Flow simulation confirmed that every pillar effectively splits the upstream flows so that the contact between the pillars and the cells are enhanced.

The shear stress for arrays with different OR was calculated from the flow field and are shown in FIG. 2D. At this region of 0 degree to 60 degree, the shear stress gradually increased to about 0.4 dyne/cm². At region larger than 60 degree, the shear stress increased abruptly for all three ORs. For OR40 and OR27, the shear stress values were very similar in this region. On the contrary, OR20 showed the highest shear stress in the corresponding region. The result could be compared with the actual cell capturing rate described below.

Actual MIPi Structure and Cell Capturing

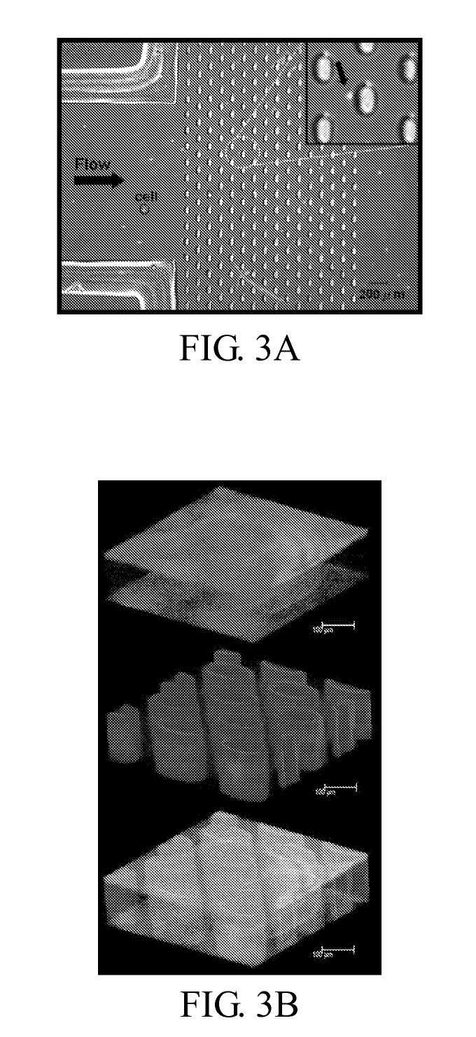

The actual MIPi array was first examined by bright-field microscopy. FIG. 3A shows a low magnification view of the uniform MIPi array. When coated with anti-EGFR, CL1-5 cells were captured on the pillar surface. Because the internal pillars is difficult to observe using SEM, the MIPi structure were confirmed by using a confocal microscope. When the pillars were coated with the Cy5-conjugated anti-mouse IgG, clear structure of the pillars was observed. FIG. 3B shows the images of the two glass layers, the internal SU-8 micro pillar, and the integrated view. This result confirms that the monolithic structure is composed of the glass and the polymer. Depending on the fixture used in the fabrication procedure, the height of the pillar was adjusted from 70 μm to 150 μm. The minimal feature size of the micro pillar obtained by using a plastic film photomask was about 20 μm.

The strong fluorescence observed on the micro pillars indicates that the antibody readily immobilized on the surface of the pillar through covalent bonding between the epoxy groups on the SU-8 surface and the amino or cysteine residues on the antibody (Blagoi, G., Keller, S., Johansson, A., Boisen, A. and Dufva, M. (2008) Functionalization of SU-8 photoresist surfaces with IgG proteins. Applied Surface Science. 255, 2896-2902). One skilled in the art would readily expect that antibodies, such as anti-EGFR and anti-mouse IgG, covalently bound to the SU-8 in a similar manner because mammalian antibodies have very similar molecular structure.

The confocal microscopic result also confirms that the internal SU-8 pillar adhered directly with the top and underlying glass layers. This ensures that particles flowing through the MIPi array would contact the pillars on the vertical surfaces. Therefore, the cell adherence could be clearly observed by a bright-field microscope, as indicated in FIG. 3A.

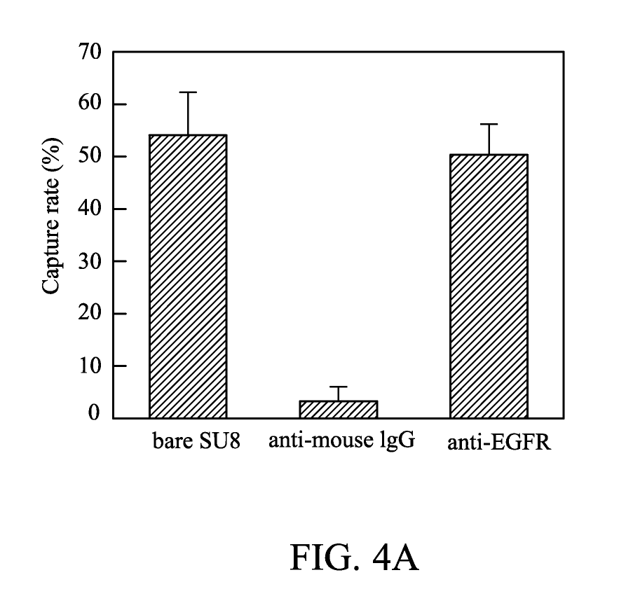

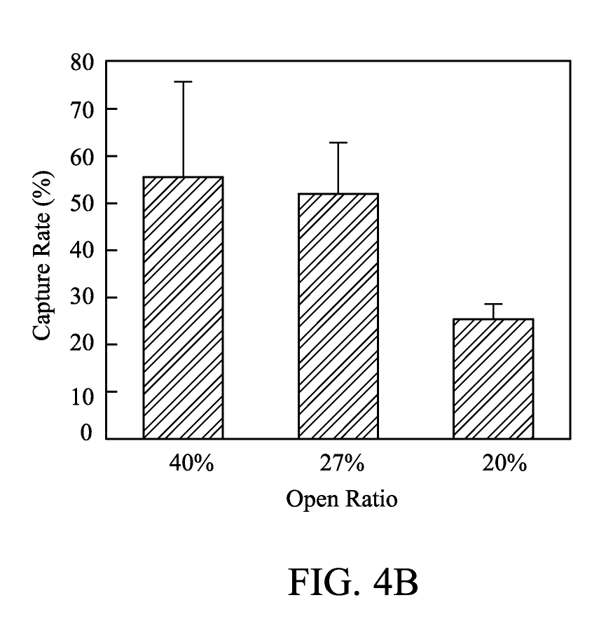

In order to examine whether the cell captured by the SU-8 micro pillars is caused by specific antibody-antigen interaction, the capturing rate by two different antibodies were compared with that by bare SU-8 pillars. Anti-EGFR has specific affinity toward the CL1-5 cell membrane EGFR. On the contrary, the Cy5-conjugated antibody has specificity toward mouse IgG and no specificity toward human cells. FIG. 4A shows that both bare SU-8 and anti-EGFR coated MIPi has high capturing rate while the anti-mouse IgG coated MIPi has almost negligible cell capturing.

The high capturing rate by bare SU-8 micro pillar indicates that cells adsorb on SU-8 surface easily. This adsorption was supposed to be caused through protein adsorption on the SU-8 surface, similar to that for antibody immobilization (Blagoi, G., Keller, S., Johansson, A., Boisen, A. and Dufva, M. (2008) Functionalization of SU-8 photoresist surfaces with IgG proteins. Applied Surface Science. 255, 2896-2902). When anti-mouse IgG (the Cy5-conjugated antibody) is used for coating, the capturing rate decreases drastically to be about 3%. As confirmed by the fluorescence image in FIG. 3B, the anti-mouse IgG indeed adsorbs on the SU-8 surface. The low capturing rate indicates that the SU-8 surface is completely covered by the antibody and non-specific binding between the anti-mouse IgG and the CL1-5 is negligible. Therefore, the high capturing rate by the anti-EGFR is attributed to the specific binding between the antibody and the CL1-5 cells.

The cell capturing rates by MIPi of different ORs were also compared, as shown in FIG. 4B. It was found that OR40 and OR27 gave similar capturing rate. Significant decrease in the capturing rate is observed for OR20. It was also observed that most cells were captured at region between 0 degree and 60 degree. This decrease in capturing rate may be attributed to the higher shear stress of OR20 obtained by the simulation.

OR40 and OR27 have similar shear stress (FIG. 3D) and similar cell capturing rate. This observation is contradictory to our initial conjecture that longer oval, e.g. OR20, would result in higher cell contact and in hence higher capturing rate. Therefore, although OR20 provides larger cell contact probability, the higher shear stress probably results in lower cell capturing. Further study on the cell capturing position will be conducted to examine the effect of local shear stress on the capturing rate.

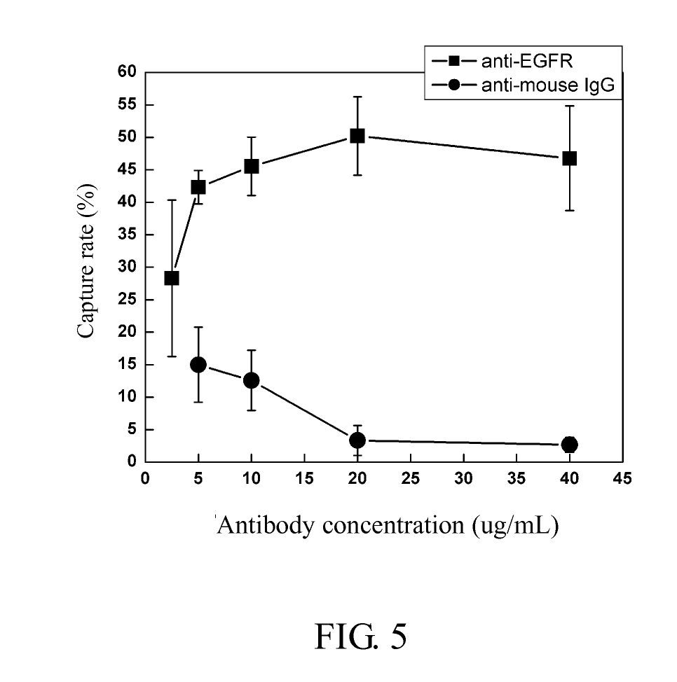

The optimal antibody concentration used for coating was further verified. The concentrations of the anti-EGFR and anti-mouse IgG were varied for coating process and the corresponding capturing rate changes are shown in FIG. 5. For anti-mouse IgG, at concentrations lower than 20 μm/ml, the capturing rate decreases monotonously with the increasing concentration. When the concentrations are higher than 20 μg/ml, the cell capturing is negligible (˜3%). The result suggests that, at low antibody concentration, the cell may be captured by the bare SU-8 surface, as also observed in FIG. 4A. However, 20 μg/ml of anti-mouse IgG is adequate for the passivation of the SU-8 surface. Therefore, the cell capturing of anti-EGFR at the concentration higher than 20 μg/ml is attributed to specific binding. However, the capturing rate starts to decrease when the concentration is higher than 20 μg/ml. This phenomenon could be understood by the fact that the over crowded antibody may sterically impair the interaction between the epitope on EGFR and the paratope on anti-EGFR. We therefore conclude that optimal antibody concentration is important for specific cell capturing. Since all antibodies have very similar molecular structure, it is expected the optimal concentration can be used for other antibodies.

Optimal Array Length

Extending the length (L) of the MIPi array is expected to prolong the time for the cells to flow through the MIPi chip, hence increasing the overall contacting probability and the resulted capturing rate. The effect is observed by using arrays with increasing columns of micro pillars.

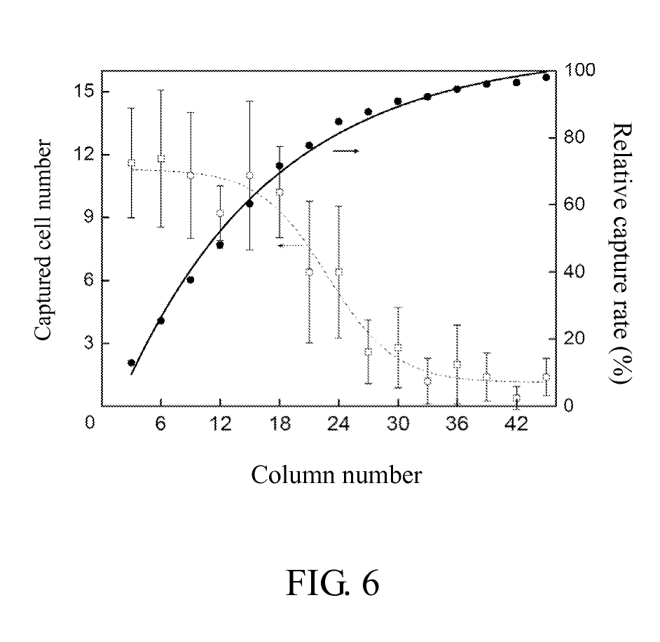

The number of cells captured by each column of pillars in the array were counted and plotted in FIG. 6. It can be seen that most of the cells were captured by the first 18 columns of pillars. After the 18^{th} column, the number of captured cells decreases rapidly. After 40^{th} column, cell capturing efficiency is only about one cell per three columns of pillars.

The accumulated number of captured cells shows an exponential recovery curve. A fitting with the exponential equation Y=Y₀−A·exp(−aX) was conducted. The Y is the relative capture rate, Y₀ the maximal capture rate, A the amplitude constant, a the recovery constant and X the column number. With aX˜=2.3, the relative capture rate reaches 90%. The curve fitted value of a is 1/15. This result suggests that 35 (X=2.3/a=2.3×15) columns of pillar are enough to have relative capture rate of 90%. The recovery constant a could be used as a guideline for efficient design of the array length. Extending the array length beyond this number does not increase the capturing rate significantly.

The relative capturing rate in FIG. 6 is compared with the overall capturing rate in FIG. 4B. In FIG. 4B, where 16 columns of pillars were used, the capturing rate for OR40 MIPi array is 54%. Using the fitted exponential function, the overall capturing rate could be raised to ˜75% when 35 columns of pillars are to be used. The 100% relative capturing rate would correspond to 84% overall capturing rate, which is lower than unity. The result indicates that extending the length of the array indefinitely will not result in complete capturing of the CL1-5 cancer cells. After certain array length, the overall capture rate reaches a plateau. The phenomenon suggests that some CL1-5 cells may not express EGFR on the cell surface so that repeated contact with anti-EGFR coated pillars does not result in increase in the capturing. Coating the MIPi array with multiple antibodies to various target proteins on a cell can result in increased capturing of the cell.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A microfluidic device comprising a monolithic internal micro pillar array fabricated from SU-8 photoresist.

2. The device of claim 1, wherein the surface of the monolithic internal micro pillar array is coated with an antibody specific to a surface protein of a cell.

3. The device of claim 2, wherein the surface of the monolithic internal micro pillar array is further coated with a second antibody specific to a second surface protein of the cell.

4. The device of claim 3, wherein the surface of the monolithic internal micro pillar array is further coated with one or more antibodies that are individually specific to their corresponding surface proteins of the cell.

5. The device of claim 1, wherein the monolithic internal micro pillar is coated with an antibody not specific to any surface protein of a cell.

6. A method of fabricating a microfluidic device, the method comprising fabricating a monolithic internal micro pillar array from SU-8 photoresist without using any bonding step.

7. A method of capturing a cell in a sample, comprising applying the sample to a microfluidic device, wherein the microfluidic device comprises a monolithic internal micro pillar array fabricated from SU-8 photoresist.

8. The method of claim 7, wherein the sample is a biological sample from a patient.

9. A method for diagnosis or prognosis of a disease or condition in a subject, the method comprising:
obtaining a biological sample from the subject; and
applying the biological sample to a microfluidic device comprising a monolithic internal micro pillar array fabricated from SU-8 photoresist, wherein the surface of the monolithic internal micro pillar array is coated with an antibody specific to a surface protein of a cell correlated with the disease or condition.
